(19) United States
(12) Patent Application Publication
(10) Pub. No.: US 2025/0258345 A1
(43) Pub. Date: Aug. 14, 2025

(54) CONNECTION STRUCTURE

(71) Applicant: IBIDEN CO., LTD., Ogaki (JP)

(72) Inventors: Kouhei KAWAI, Ibi-gun (JP); Haruka FURUMACHI, Ibi-gun (JP)

(73) Assignee: IBIDEN CO., LTD., Ogaki (JP)

(21) Appl. No.: 19/169,044

(22) Filed: Apr. 3, 2025

Related U.S. Application Data
(63) Continuation of application No. PCT/JP2023/033610, filed on Sep. 14, 2023.

(30) Foreign Application Priority Data
Oct. 4, 2022 (JP) 2022-160441

(51) Int. Cl. G02B 6/42

(52) U.S. Cl. CPC G02B 6/4202

(57) ABSTRACT

A connection structure includes an electrical wiring part, an optical element having a light receiving or light emitting surface, and an optical waveguide including a core part, a first cladding layer in contact with a first surface of the core part, and a second cladding layer in contact with a second surface of the core part on the opposite side. The waveguide has a first end surface and a second end surface formed such that the core part and first cladding layer are substantially flush on the first end surface and the second cladding layer has the second end surface extending from the first end surface, the core part has a light transmitting surface that is exposed on the first end surface and faces the light receiving or light emitting surface of the optical element, and the optical element is positioned on the second end surface of the optical waveguide.

### CROSS-REFERENCE TO RELATED APPLICATIONS

The present application is a continuation of and claims the benefit of priority to International Application No. PCT/JP2023/033610, filed Sep. 14, 2023, which is based upon and claims the benefit of priority to Japanese Application No. 2022-160441, filed Oct. 4, 2022. The entire contents of these applications are incorporated herein by reference.

### BACKGROUND OF THE INVENTION

### Field of the Invention

The present invention relates to a connection structure between an optical waveguide and an optical element.

### Description of Background Art

Japanese Patent Application Laid-Open Publication No. 2018-141910 describes an optical waveguide. The entire contents of this publication are incorporated herein by reference.

### SUMMARY OF THE INVENTION

According to one aspect of the present invention, a connection structure includes an electrical wiring part, an optical element positioned on an electrical part and having a light receiving surface or a light emitting surface, and an optical waveguide positioned on the electrical wiring part and including a core part, a first cladding layer formed in contact with a first surface of the core part, and a second cladding layer formed in contact with a second surface of the core part on the opposite side with respect to the first surface. The optical waveguide has a first end surface and a second end surface formed such that the core part and the first cladding layer are substantially flush on the first end surface and that the second cladding layer has the second end surface extending from the first end surface, the core part of the optical waveguide has a light transmitting surface that is exposed on the first end surface and faces the light receiving surface or light emitting surface of the optical element, and the optical element is positioned on the second end surface of the optical waveguide.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view illustrating an example of a wiring substrate that includes a connection structure according to an embodiment of the present invention;

FIG. 2 is a plan view illustrating an example of a plan view of the wiring substrate of FIG. 1;

FIG. 3 is an enlarged view of a portion (III) of FIG. 1;

FIG. 4 is a cross-sectional view illustrating a modified example of a wiring substrate that includes a connection structure according to an embodiment of the present invention;

FIG. 5A is a cross-sectional view illustrating an example of a process for forming a connection structure according to an embodiment of the present invention;

FIG. 5B is a cross-sectional view illustrating an example of a process for forming a connection structure according to an embodiment of the present invention;

FIG. 5C is a cross-sectional view illustrating an example of a process for forming a connection structure according to an embodiment of the present invention;

FIG. 5D is a cross-sectional view illustrating an example of a process for forming a connection structure according to an embodiment of the present invention;

FIG. 5E is a cross-sectional view illustrating an example of a process for forming a connection structure according to an embodiment of the present invention;

FIG. 5F is a cross-sectional view illustrating an example of a process for forming a connection structure according to an embodiment of the present invention;

FIG. 5G is a cross-sectional view illustrating an example of a process for forming a connection structure according to an embodiment of the present invention; and

FIG. 5H is a cross-sectional view illustrating an example of a process for forming a connection structure according to an embodiment of the present invention.

### DETAILED DESCRIPTION OF THE EMBODIMENTS

Embodiments will now be described with reference to the accompanying drawings, wherein like reference numerals designate corresponding or identical elements throughout the various drawings.

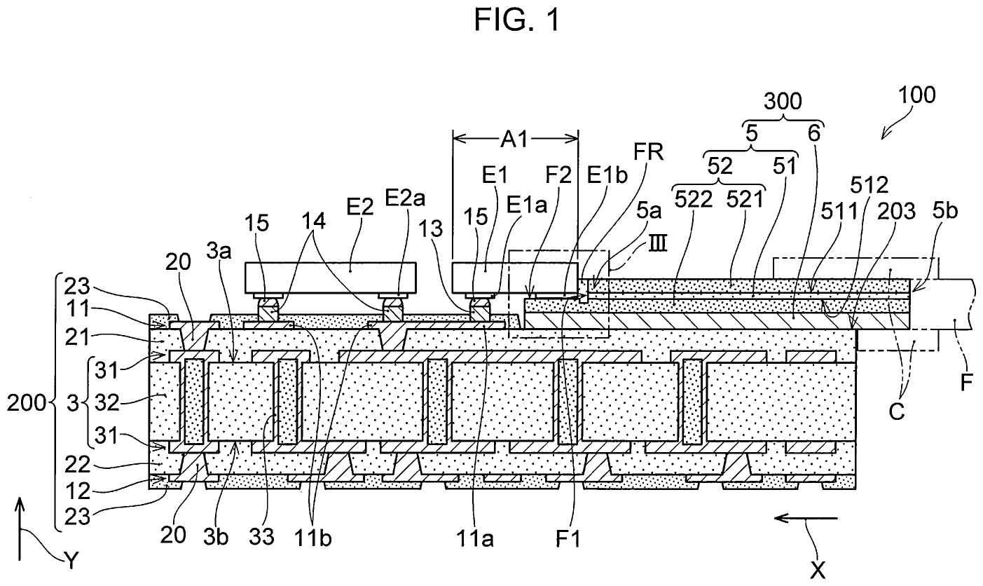

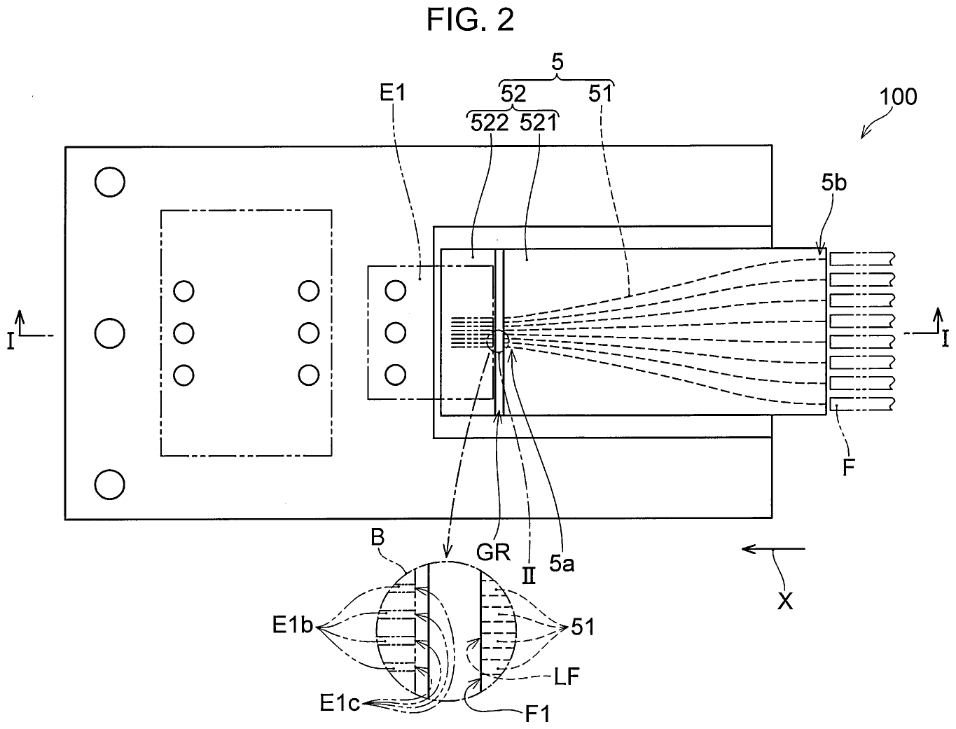

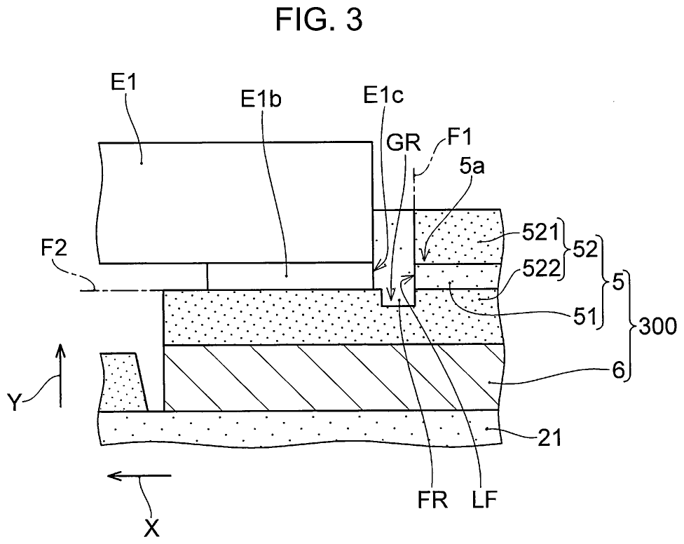

A connection structure according to an embodiment of the present invention is described with reference to the drawings. FIG. 1 illustrates a connection structure between an optical waveguide 5 and a component (optical element) (E1), which is an example of the connection structure of the embodiment. A wiring substrate 100 is formed by attaching the optical waveguide 5 to an electrical wiring part 200 via a support plate 6. FIG. 1 illustrates a state in which the component (E1) is positioned on a surface of the wiring substrate 100 on a side where the optical waveguide 5 is attached. FIG. 2 illustrates a plan view of the wiring substrate 100 illustrated in FIG. 1. FIG. 1 is a cross-sectional view along an I-I line in FIG. 2. The term “plan view” means viewing the wiring substrate 100 along a thickness direction thereof. An enlarged view of a portion (II) of FIG. 2 is illustrated in a circle (B) depicted using a one-dot chain line in FIG. 2. FIG. 3 illustrates an enlarged view of a portion (III) of FIG. 1.

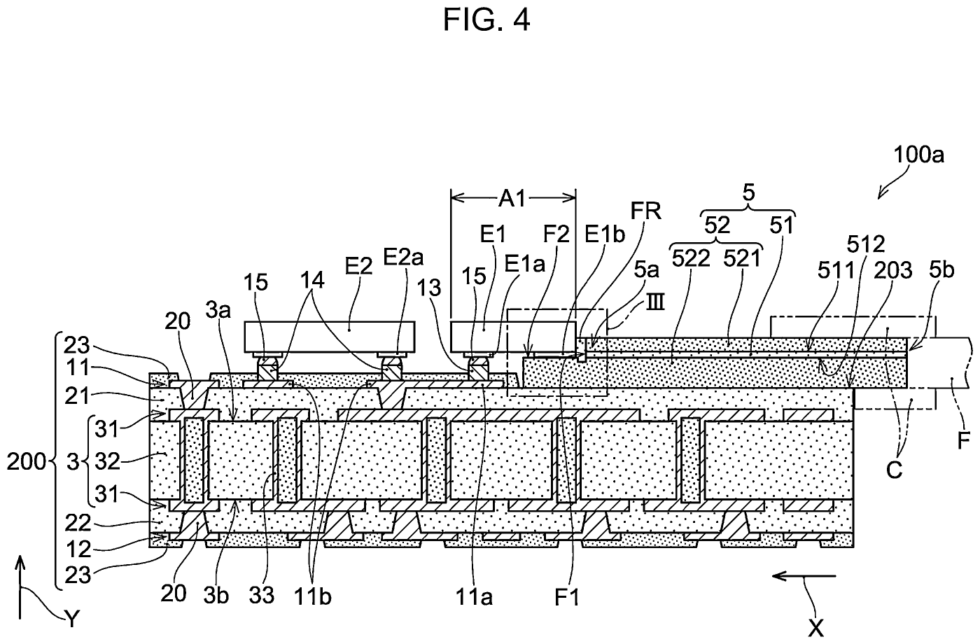

The wiring substrate 100 in the example illustrated in FIG. 1 includes the electrical wiring part 200 and an optical wiring part 300, which is placed on a surface 203 of the electrical wiring part 200. The optical wiring part 300 includes the optical waveguide 5 and the support plate 6 of the embodiment. The electrical wiring part 200 includes insulating layers and conductor layers. A wiring substrate (100a) of a modified example illustrated in FIG. 4 does not include a support plate, and the optical waveguide 5 is positioned on the wiring substrate (100a). In FIG. 4, the optical waveguide 5 is formed on an insulating layer 21. However, it is also possible that the optical waveguide 5 is formed on a solder resist 23.

The electrical wiring part 200 of FIG. 1 includes: a core substrate 3 that has a surface (3a) on one side and a surface (3b) on the other side, the surfaces (3a, 3b) opposing each other in a thickness direction thereof; an insulating layer 21 and a conductor layer 11 that are sequentially laminated on the surface (3a) of the core substrate 3; and an insulating layer 22 and a conductor layer 12 that are sequentially laminated on the surface (3b) of the core substrate 3. The insulating layer 21 is an interlayer insulating layer interposed between the conductor layer 11 and a conductor layer 31, and the insulating layer 22 is an interlayer insulating layer interposed between the conductor layer 12 and a conductor layer 31. In each of the insulating layer 21 and the insulating layer 22, via conductors 20 connecting the conductor layers that sandwich the insulating layer 21 or the insulating layer 22 to each other are formed. The core substrate 3 includes an insulating layer 32, and the conductor layers 31 that are respectively formed on both sides of the insulating layer 32. The insulating layer 32 is provided with through-hole conductors 33 that penetrate the insulating layer 32 and connects the conductor layers 31 on both sides of the insulating layer 32 to each other.

In the electrical wiring part 200, a solder resist 23 is formed on each of the surface (3a) side and the surface (3b) side of the core substrate 3. The solder resist 23 on the surface (3a) side covers necessary portions of the insulating layer 21 and conductor layer 11. Further, the solder resist 23 on the surface (3b) side covers necessary portions of the insulating layer 22 and conductor layer 12.

In the electrical wiring part 200, conductor posts (13, 14) are formed on the conductor layer 11. A connection layer 15 is formed on surfaces of the conductor posts (13, 14) using, for example, tin-based solder, gold-based or silver-based solder, or the like. The conductor posts (13, 14) each have, for example, a columnar shape extending from the conductor layer 11 in a direction away from the insulating layer 21. The conductor posts (13, 14) protrude from a surface of the solder resist 23. The component (E1) is connected to the conductor posts 13, and a component (E2) is connected to the conductor posts 14. Therefore, the electrical wiring part 200 has a component mounting region (A1), which is a region where the component (E1) is mounted when the wiring substrate 100 is used. The component mounting region (A1) is covered by the component (E1) when the wiring substrate 100 is used.

The insulating layers (21, 22) and the insulating layer 32 are each formed of, for example, an insulating resin such as an epoxy resin, a bismaleimide triazine resin (BT resin), or a phenol resin. Further, although not illustrated, the insulating layers each may contain a core material (reinforcing material) formed of a glass fiber, an aramid fiber, or the like, and each may contain an inorganic filler formed of fine particles of silica (SiO₂), alumina, mullite, or the like. On the other hand, the solder resist 23 is formed of, for example, a photosensitive epoxy resin, a photosensitive polyimide resin, or the like.

The conductor layers (11, 12), the conductor layers 31, the through-hole conductors 33, the via conductors 20, and the conductor posts (13, 14) can be formed using any metal such as copper or nickel. In FIG. 1, these conductors are simplified and depicted as each having a one-layer structure. However, these conductor posts can each have a multilayer structure including two or more metal layers. For example, the conductor layers (11, 12) can each have a two-layer structure including an electroless plating film and an electrolytic plating film. The conductor posts (13, 14) are formed of, for example, plating metal deposited by electroless plating and/or electrolytic plating. Further, the conductor posts (13, 14) may be formed not only by plating, but also by sputtering or applying conductive paste.

The conductor layers (11, 12) and the conductor layers 31 can each include any conductor patterns. In the example of FIG. 1, the conductor layer 11 includes conductor pads (11a, 11b). The conductor posts 13 are formed on the conductor pads (11a), and electrodes (E1a) of the component (E1) are electrically connected to the conductor pads (11a) via the conductor posts 13. Similarly, the conductor posts 14 are formed on the conductor pads (11b), and electrodes (E2a) of the component (E2) are electrically connected to the conductor pads (11b) via the conductor posts 14.

When the wiring substrate 100 is used, an electrical component (that is, an optical element) that includes a light receiving element and/or a light emitting element and has a photoelectric conversion function is mounted in the component mounting region (A1) as the component (E1). The component (E1) includes a light guiding part (E1b), which is a light receiving part or light emitting part, in addition to the electrodes (E1a). Referring to FIG. 3, the light guiding part (E1b), which is a light receiving part or light emitting part, has a light receiving or light emitting surface (E1c). In the illustrated example, the electrodes (E1a) and the light guiding part (E1b), which is a light receiving part or light emitting part, are provided on a surface of the component (optical element) (E1) facing the wiring substrate 100 side. That is, in the example of FIGS. 1-3, the component (E1) is mounted by so-called face-down mounting (flip-chip mounting).

Examples of the component (E1) include light receiving elements such as a photodiode; and light emitting elements such as a light emitting diode (LED), an organic light emitting diode (OLED), a laser diode (LD), and a vertical cavity surface emitting laser (VCSEL). When the component (E1) is a light emitting element, the component (E1) generates an optical signal based on an electrical signal input to the electrodes (E1a) and emits the optical signal from the light guiding part (E1b), which is a light receiving part or light emitting part and functions as a light emitting part. Further, when the component (E1) is a light receiving element, an electrical signal is generated based on an optical signal input to the light guiding part (E1b), which is a light receiving part or light emitting part and functions as a light receiving part, and is output from the electrodes (E1a).

The component (E2) can be, for example, an electronic component such as a semiconductor device that generates an electrical signal that causes the component (E1) to emit light, and/or processes an electrical signal generated by the component (E1). Examples of the component (E2) include semiconductor devices such as a general-purpose operational amplifier, a driver IC, a microcomputer, and a programmable logic device (PLD).

The optical waveguide 5 is included in the optical wiring part 300. The optical waveguide 5 includes a core part 51 that transmits an optical signal and a cladding part 52 that surrounds the core part 51. In FIG. 1, the optical wiring part 300 further includes the support plate 6. The support plate 6 is positioned on the electrical wiring part 200. The optical waveguide 5 is positioned on the support plate 6. Examples of materials for the support plate 6 include: glasses such as soda-lime glass, borosilicate glass, and quartz glass; various metals such as tungsten, titanium, and molybdenum; various ceramics such as alumina, silicon nitride, and silicon oxide; and the like. The various metals forming the support plate 6 may be in a form of a metal plate or a metal foil. The optical waveguide 5 may be positioned on the surface 203 of the electrical wiring part 200.

The cladding part 52 includes a first cladding layer 521 and a second cladding layer 522. The cladding part 52 is provided around the core part 51 and sandwiches the core part 51 in any direction perpendicular to a direction extending from a surface where the core part 51 is exposed, that is, a propagation direction of an optical signal in the core part 51 (+X or −X direction, hereinafter collectively referred to as an “X direction”). Specifically, the core part 51 has a first surface 511 (a side of the core part 51 on an opposite side with respect to the electrical wiring part 200) and a second surface 512 (a side of the core part 51 facing the electrical wiring part 200), and the first cladding layer 521 of the cladding part 52 is in contact with the first surface 511 of the core part 51, and the second cladding layer 522 is in contact with the second surface 512 of the core part 51.

The core part 51 has a first end part (5a) and a second end part (5b), which are end parts in the extending direction. The second end part (5b) is an end part on an opposite side with respect to the first end part (5a). An optical signal enters an end part of the core part 51 from outside the optical waveguide 5 by passing through a surface of the core part 51 that is not covered by the cladding part 52. Further, an optical signal exits an end part of the core part 51 from the core part 51 to outside of the optical waveguide 5 by passing through a surface of the core part 51 that is not covered by the cladding part 52. The first end part (5a) and the second end part (5b) each have a light transmitting surface (LF) that is a surface facing the outside of the optical waveguide 5 and where the core part 51 is exposed and not covered by the cladding part 52, and that allows transmission of an optical signal propagating in the core part 51.

The core part 51 and the cladding part 52 that form the optical waveguide 5 are each formed using a material having an appropriate refractive index. The core part 51 and the cladding part 52 can each be formed of, for example, an organic material (organic substance), an inorganic material (inorganic substance), or an organic-inorganic mixed material, such as an inorganic polymer, containing an organic component and an inorganic component. Examples of inorganic materials include quartz glass, silicon, and the like. Examples of organic materials include thermosetting resins, ultraviolet-curing resins, thermoplastic resins, and the like, and it is desirable to use a thermosetting resin or an ultraviolet-curing resin. Specifically, examples of organic materials include acrylic resins such as polymethylmethacrylate (PMMA), polyimide resins, polyamide resins, polyether resins, epoxy resins, and the like. An optical waveguide 5 formed of an organic material tends to be lightweight and highly flexible. Further, an organic material is excellent in processability for a waveguide, and allows a first end surface and a second end surface, which are end parts of the waveguide, to be easily formed. Further, the first end surface and the second end surface, which are the end parts of a waveguide formed of an organic material, can each have a surface roughness adjusted to a desired numerical range. In a waveguide formed of an organic material (organic substance), a recess can also be relatively easily formed.

The core part 51 and cladding part 52 may be formed of materials different from each other or may be formed of materials of the same type. However, for the core part 51, a material having a higher refractive index than that used for the cladding part 52 is used so that total reflection of an optical signal at an interface between the core part 51 and the cladding part 52 is possible. It is also possible that, after the core part 51 and the cladding part 52 are formed using materials having the same refractive index, the refractive indices of the core part 51 and the cladding part 52 are made different from each other by appropriate processing.

In the connection structure between the optical waveguide 5 and the component (optical element) (E1) on the wiring substrate of the embodiment, as illustrated in the drawing, one end part of the optical waveguide 5 on the first end part (5a) side of the core part 51 has a first end surface (F1) and a second end surface (F2).

### First End Surface

The light transmitting surface (LF) is provided on an exposed surface at the first end part (5a), and forms a surface that coincides with an exposed surface of the core part extending perpendicular to the X-direction of the first cladding layer 521. A surface where the exposed surface of the core part at the first end part (5a) of the core part 51 and a side surface of the first cladding layer 521 coincide is referred to as the first end surface (F1). At the first end surface (F1), the exposed surface of the core part 51 at the first end part (5a) of the core part 51 and the end surface of the first cladding layer 521 at the first end part (5a) are formed substantially flush. In other words, at the first end surface (F1), the core part 51 and the first cladding layer 521 are substantially flush.

### Second End Surface

On the first end part (5a) side of the core part 51 of the optical waveguide 5, the second cladding layer 522 is provided on an opposite side with respect to the first cladding layer 521 of the core part 51, and the second cladding layer 522 extends from the first end surface (F1) in the propagation direction (X direction) of the optical waveguide 5. That is, at the end part of the optical waveguide 5 on the first end surface (F1) side in the X direction, a portion of the surface of the second cladding layer 522 that is in contact with the core part 51 extends and is exposed. This exposed surface of the second cladding layer 522 on the side in contact with the core part 51 is referred to as the second end surface (F2). In the example of FIG. 1, the second end surface (F2) overlaps with the component mounting region (A1) of the wiring substrate 100 in a plan view. It is also possible that the second end surface (F2) does not overlap with the component mounting region (A1) of the wiring substrate 100.

As illustrated in the circle (B) of FIG. 2 and in FIG. 3, in the connection structure between the optical waveguide 5 and the component (optical element) (E1) on the wiring substrate 100 of the embodiment, the light transmitting surface (LF) is provided on the first end surface (F1) at the first end part (5a) of the core part 51, and is formed to face the light guiding part (E1b), which is a light receiving part or light emitting part of the component (optical element) (E1). That is, in the connection structure between the optical waveguide 5 and the component (optical element) (E1) on the wiring substrate 100 of the embodiment, in mounting the component (E1) in the component mounting region (A1), the light receiving or light emitting surface (E1c) of the component (E1) is aligned to face the light transmitting surface (LF) at the first end part (5a) in an exposed state.

As illustrated in FIG. 3, the component (optical element) (E1) is positioned on the second end surface (F2) of the second cladding layer 522 on an inner side of the cladding part 52 such that the light receiving or light emitting surface (E1c) of the component (optical element) (E1) faces and optically couples with the light transmitting surface (LF) at the first end part (5a) of the core part 51. On the other hand, as illustrated in FIGS. 1 and 2, the end surface on the second end part (5b) side of the core part 51 is positioned to face and optically couple with an optical fiber (F) that is connected to the optical waveguide 5 when the wiring substrate 100 is used. For example, as illustrated in FIG. 1, the optical fiber (F) and the optical waveguide 5 are connected using a connector (C). It is also possible that the optical waveguide 5 is connected to another optical waveguide instead of the optical fiber (F).

Since the component (optical element) (E1) and the optical waveguide 5 are positioned in this way, an optical signal propagated through the optical fiber (F) enters the optical waveguide 5 from the second end part (5b) of the core part 51, propagates through the core part 51, and enters the component (E1) from the first end part (5a) of the waveguide via the light guiding part (E1b), which is a light receiving part or light emitting part. That is, the component (E1) is optically coupled with an optical signal transmitted through the optical waveguide 5. Specifically, an optical signal propagating through the core part 51 toward the first end part (5a) enters the light guiding part (E1b), which is a light receiving part or light emitting part of the component (E1), via the light transmitting surface (LF) in a propagation direction of the optical signal. That is, when the wiring substrate 100 is used, the light transmitting surface (LF) of the core part 51 is butt coupled to the light guiding part (E1b), which is a light receiving part or light emitting part of the component (E1).

An optical signal entered the component (E1) is converted into an electrical signal in the component (E1), and the electrical signal is output from the electrodes (E1a). The output electrical signal is input to the component (E2) via the conductor layer 11 and is processed. On the other hand, an electrical signal output from the component (E2) toward the component (E1) is input to the component (E1) via the electrodes (E1a) and is converted into an optical signal. The optical signal is emitted from the light guiding part (E1b), which is a light receiving part or light emitting part, and enters the optical waveguide 5 from the first end part (5a). An optical signal that has entered propagates through the core part 51 and is emitted from the second end part (5b) to the optical fiber (F).

As illustrated in FIG. 2, the optical waveguide 5 has eight core parts 51 that are formed in parallel. In this way, the optical waveguide 5 has multiple core parts 51. For example, it may be possible that multiple optical fibers (F) optically coupled with the core parts 51 at the second end parts (5b) cannot be formed at a pitch as small as a formation pitch of multiple light guiding parts (E1b), which are multiple light receiving parts or light emitting parts provided in the component (E1). Therefore, as in the example in FIG. 2, it may be possible that the multiple optical fibers (F) are formed at a pitch larger than the formation pitch of the light guiding parts (E1b), which are light receiving parts or light emitting parts. In the example of FIG. 2, the multiple core parts 51 are formed at a larger pitch at the second end parts (5b) than at the first end parts (5a). Therefore, it is thought that, at the first end parts (5a) and the second end parts (5b), the component (E1) or the optical fibers (F) can be appropriately optically coupled with the core parts 51 without requiring a separate pitch conversion measure. The number of the core parts 51 in the optical waveguide 5 is not particularly limited, but is preferably 4 to 32.

In the connection structure between the optical waveguide 5 and the component (optical element) (E1) of the embodiment, the light transmitting surface (LF) at the first end part (5a) of the core part 51 in the optical waveguide 5 is exposed on the first end surface (F1). That is, the core part 51 is exposed on the first end surface (F1). Therefore, in a state in which the optical wiring part 300 is mounted on the electrical wiring part 200, a position of the light transmitting surface (LF) of the core part 51 on the first end surface (F1) can be relatively easily recognized. Further, in mounting the component (E1) in the component mounting region (A1), the light receiving or light emitting surface (E1c) of the component (E1) is aligned with the light transmitting surface (LF) of the first end surface (F1) at the first end part (5a) in an exposed state. Mounting the component (E1) in the component mounting region (A1) means placing the component (E1) on the second end surface (F2).

Therefore, alignment of the light receiving or light emitting surface (E1c) of the component (E1) with respect to the exposed light transmitting surface (LF) at the first end part (5a) of the core part 51 can be relatively easily performed. Specifically, a distance (inter-surface distance) between the light transmitting surface (LF) at the first end part (5a) of the core part 51 and the light receiving or light emitting surface (E1c) of the component (E1) can be relatively easily adjusted to achieve good optical coupling between the light guiding part (E1b), which is a light receiving part or light emitting part of the component (E1), and the core part 51. Therefore, in the connection structure between the optical waveguide 5 and the optical element E1, which is a component, on the wiring substrate 100 of the embodiment, positions of the light transmitting surface (LF) at the first end part (5a) of the core part 51 and the light receiving or light emitting surface (E1c) of the component (E1) can be aligned with relatively high accuracy, and thus good optical coupling can be achieved.

Further, in the optical waveguide 5, the first end surface (F1) is preferably a polished surface. A surface roughness (R1) of the first end surface (F1) is preferably, for example, 0.10 μm or less in terms of arithmetic mean roughness, and more preferably 0.01 μm or more and 0.09 μm or less in terms of arithmetic mean roughness. Therefore, more precise adjustment can be performed in the inter-surface distance in the alignment between the light transmitting surface (LF) at the first end part (5a) of the core part 51 and the light receiving or light emitting surface (E1c) of the component (E1). For example, a filler (FR), which is a translucent filling resin, may be formed in a gap between the light transmitting surface (LF) at the first end part (5a) of the core part 51 and the light receiving or light emitting surface (E1c) of the component (E1) after the formation of the component (E1) with respect to the optical waveguide 5 has been completed. By setting the surface roughness (R1) of the first end surface (F1) to 0.10 μm or less in terms of arithmetic mean roughness, incidence of an optical signal to the core part 51 and emission of an optical signal from the core part 51 at the first end surface (F1) can be efficiently performed. Further, by setting the surface roughness (R1) of the first end surface (F1) to 0.10 μm or less in terms of arithmetic mean roughness, formation of the filling resin is unlikely to be hindered. Further, by setting the surface roughness (R1) of the first end surface (F1) to 0.01 μm or more and 0.09 μm or less in terms of arithmetic mean roughness, incidence of an optical signal to the core part 51 and emission of an optical signal from the core part 51 at the first end surface (F1) can be more efficiently performed. Further, in the formation of the filling resin, a gap is unlikely to be formed and a satisfactory filling is likely to be achieved.

The second end surface (F2) of the optical waveguide 5, on which the component (E1) is placed, extends in the X direction from the first end surface (F1). A length of the second end surface (F2) extending in the X direction from the first end surface (F1) is not particularly limited, but is preferably equal to or greater than a length of the first end surface (F1). In this case, the length of the first end surface (F1) means a sum of a thickness of the first cladding layer 521 and a thickness of the core part 51. It is thought that the component (E1) may be relatively stably placed on the second end surface (F2) of the second cladding layer 522. Further, a surface roughness (R2) of the second end surface (F2) is not particularly limited, but is preferably 0.10 μm or less in terms of arithmetic mean roughness, and more preferably 0.001 μm or more and 0.08 μm or less in terms of arithmetic mean roughness. By setting the surface roughness (R2) of the second end surface (F2) to 0.10 μm or less in terms of arithmetic mean roughness it is thought that the formation of the translucent filling resin is unlikely to be hindered when the component (E1) has been positioned. By setting the surface roughness (R2) of the second end surface (F2) to 0.001 μm or more and 0.08 μm or less in terms of arithmetic mean roughness, it is thought that the translucent filling resin can be formed without any gap when the component (E1) has been positioned. It is thought that the component (E1) is more stably placed on the second cladding layer 522, and thus, the accuracy of the alignment of the component (E1) with respect to the optical waveguide 5 in the thickness direction is improved. Specifically, when the alignment of the light receiving or light emitting surface (E1c) of the component (E1) with respect to the exposed light transmitting surface (LF) at the first end part (5a) of the core part 51 is performed, accuracy of the alignment in the thickness direction is improved. As an example of the embodiment, the surface roughness (R1) of the first end surface (F1) is 0.04 μm in terms of arithmetic mean roughness, and the surface roughness (R2) of the second end surface (F2) is 0.006 μm in terms of arithmetic mean roughness.

In the description of the present specification, “surface roughness” means the arithmetic mean roughness (Sa) defined by ISO 25178. In measuring the surface roughness, a measurement target area of 30 μm×30 μm is specified, and the measurement is performed using a laser-type surface roughness measuring device (Keyence VK-X210). An average value of measurement results at five points in the measurement target area is regarded as the surface roughness.

As illustrated in FIG. 3, the second cladding layer 522 of the optical waveguide 5 has a recess (GR) at a corner part between the second end surface (F2) and the first end surface (F1) (a peripheral edge of the first end surface (F1)). As can be seen from the plan view illustrated in FIG. 2, the recess (GR) extends in a width direction of the optical waveguide 5, which is orthogonal to the X direction. Further, as illustrated in FIG. 3, among inner wall surfaces of the recess (GR), an inner wall surface on the first end surface (F1) side is continuous and substantially flush with the first end surface (F1). The corner part between the second end surface (F2) and the first end surface (F1) is also a peripheral edge of the first end surface (F1). The recess (GR) may be formed at the corner part between the second end surface (F2) and the first end surface (F1), which is a peripheral edge of the first end surface (F1).

The recess (GR) is formed in a region between the component mounting region (A1) and the first end surface (F1). That is, the recess (GR) is formed in the second cladding layer 522 in a region between the first end surface (F1) and the surface of the component (E1) facing the first end surface (F1) in a state in which the component (E1) is mounted on the wiring substrate 100 (a state in which the component (E1) is placed on the optical waveguide 5). A depth of the recess (GR) in the thickness direction (Y direction) of the second cladding layer 522 (a shortest distance from an upper surface of the second end surface (F2) to a bottom part of the recess (GR)) is preferably 5 μm or more. A width of the recess (GR) in the extension direction (X direction) of the optical waveguide 5 (a shortest distance from one inner wall surface to the other inner wall surface) is preferably, for example, 1 μm or more. Further, the state in which the component (E1) is mounted on the wiring substrate 100 also means the state in which the component (E1) is placed on the optical waveguide 5. The width of the recess (GR) means the shortest distance from one inner wall surface to the other inner wall surface of the recess in a cross section thereof.

In a state in which the component (E1) is placed on the optical waveguide 5, a translucent filling resin may be formed in a gap between the light transmitting surface (LF) (see FIG. 2) at the first end part (5a) of the core part 51 and the light receiving or light emitting surface (E1c) of the component (E1). In this case, the resin filling the gap can also fill the recess (GR). By forming the filling resin in the recess (GR), an anchor effect of the resin filling the recess (GR) is obtained, and a contact area of the filling resin and a surface of the component (E1) with a surface of the optical waveguide 5 is increased, allowing the component (E1) and the optical waveguide 5 to be more firmly fixed via the resin. Therefore, it is thought that a risk such as a reduction in light propagation efficiency due to a misalignment of the light receiving or light emitting surface (E1c) of the component (E1) with respect to the exposed light transmitting surface (LF) at the first end part (5a) of the core part 51 can be suppressed. It is also possible that the filling resin is not formed between the component (optical element) (E1) and the first end surface (F1). Further, in the illustrated example, there is a gap between the component (optical element) (E1) and the second end surface (F2). However, it is also possible that a filling resin is also formed in this gap. In the case of filling with a resin, a filling resin same as the resin interposed between the component (E1) and the first end surface (F1) may be formed in a portion on a lower side of the component (E1), or different filling resins may be respectively formed.

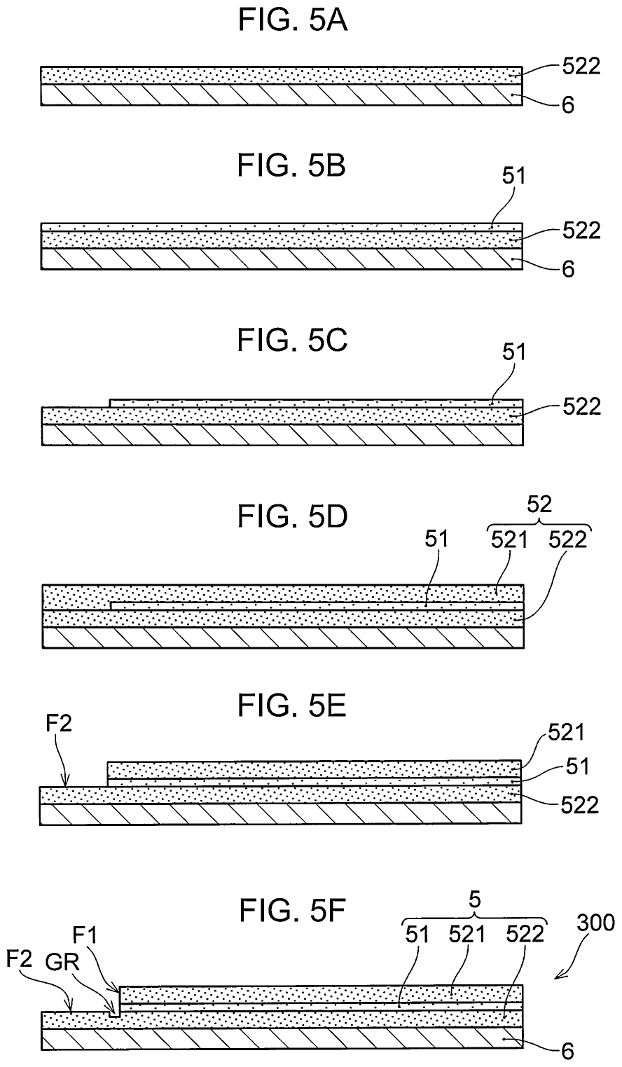

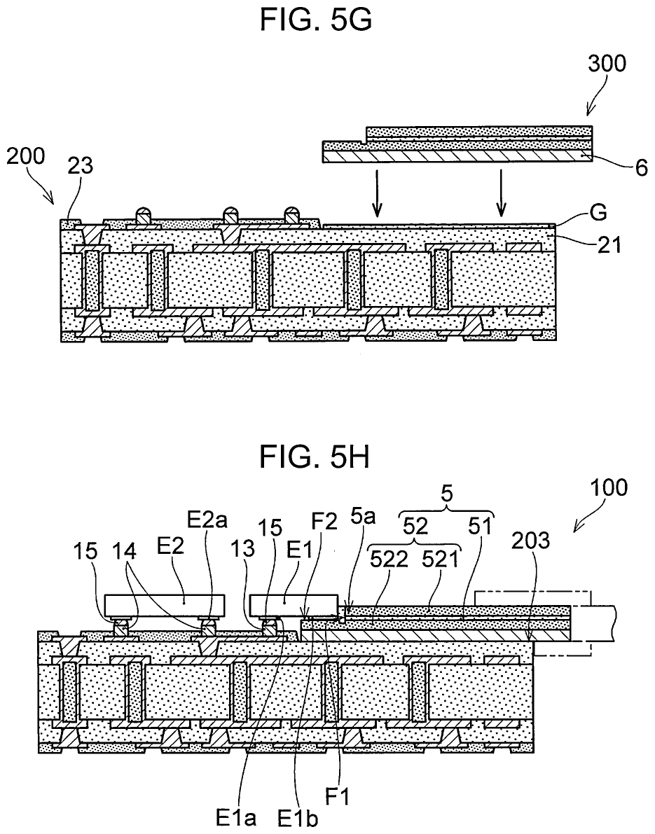

Next, with reference to FIGS. 5A-5H, a method for forming the connection structure between the optical waveguide 5 and the component (optical element) (E1), as illustrated in FIG. 1, is described. The method for forming the connection structure described below is an example, and a method other than the method described with reference to FIGS. 5A-5H can also be implemented as a method for forming the optical waveguide 5.

First, the optical waveguide 5 is formed. As illustrated in FIG. 5A, for example, a glass plate is prepared as the support plate 6, and the second cladding layer 522 is formed on a surface of the support plate 6. For example, a resin material, such as PMMA, which is the constituent material of the cladding part 52 (see FIG. 1), is molded into a film and thermocompression bonded onto the support plate 6. In addition to thermocompression bonding, it may also be formed by applying a resin material to the support plate 6 by spin coating or the like.

Next, as illustrated in FIG. 5B, an acrylic resin or the like as a resin material constituting the core part 51 is formed into a film and laminated on a surface of the second cladding layer 522 on an opposite side with respect to the support plate 6. The core part 51 may also be formed by applying the resin material constituting the core part 51 by spin coating or the like.

Next, as illustrated in FIG. 5C, the core part 51 having a desired pattern is formed by photolithography using a mask having openings corresponding to a pattern that the core part 51 on the second cladding layer 522 should have. In forming the pattern of the core part 51, a portion of the core part 51 corresponding to the second end surface (F2) is entirely removed. For example, in forming the pattern of the core part 51, the core part 51 corresponding to an area of the second cladding layer 522 where an external component is to be placed is entirely removed.

Next, as illustrated in FIG. 5D, the first cladding layer 521 is formed on the core part 51 and on the second cladding layer 522 exposed from the pattern of the core part 51. For example, similarly to the formation of the second cladding layer 522, a resin material such as PMMA is molded into a film, and the film-like resin material is thermocompression bonded onto the second cladding layer 522 and the core part 51. The first cladding layer 521 is integrated with or at least tightly adhered to the second cladding layer 522, and thereby, the cladding part 52 surrounding the core part 51 is formed. The first cladding layer 521 may also be formed by applying a resin material constituting the first cladding layer 521 by spin coating or the like.

Next, as illustrated in FIG. 5E, an unwanted portion of the first cladding layer 521 is removed by photolithography. Specifically, the first cladding layer 521 corresponding to a region where the core part 51 is not formed in a plan view is removed. In the second cladding layer 522, the second end surface (F2) corresponding to an area where an external component is to be placed is exposed. In the process illustrated in FIG. 5D, the first cladding layer 521 may also be formed by thermocompression bonding or applying the resin material of the first cladding layer 521 onto the core part 51 such that the second end surface (F2) of the second cladding layer 522 is not covered.

Next, as illustrated in FIG. 5F, the first end surface (F1) is formed, for example, by laser processing using CO₂ laser, UV laser or the like. In forming the first end surface (F1), a part of the core part 51 and a part of the first cladding layer 521 in the state illustrated in FIG. 5E can be cut by laser processing to have a mirror finish. Further, in addition to laser processing, a mirror finish may also be achieved by dicing or a chemical treatment. The first end surface (F1) is formed as a surface having a roughness of 0.1 μm or less in terms of arithmetic mean roughness.

Further, at the same time as the formation of the first end surface (F1) by cutting the core part 51 and the first cladding layer 521, the recess (GR) is formed in the second cladding layer 522. The recess is formed to have a depth of 5 μm or more in the thickness direction of the second cladding layer 522. The width of the recess (GR) in the extension direction of the optical waveguide 5 (a shortest distance from one inner wall surface to the other inner wall surface) is formed to be, for example, 1 μm or more. The formation of the first end surface (F1) and the recess (GR) described with reference to FIG. 5F may be performed using a method other than laser processing, such as dicing. In the state illustrated in FIG. 5F, the surface roughness (R2) of the second end surface (F2) is, for example, 0.1 μm or less in terms of arithmetic mean roughness. Further, it is preferable that the surface roughness of the second end surface (F2) is equal to or less than the surface roughness of the first end surface (F1). Further, the surface roughness (R1) of the first end surface (F1) is, for example, 0.1 μm or less in terms of arithmetic mean roughness. It is preferable that a relationship between the surface roughness (R2) of the second end surface (F2) and the surface roughness (R1) of the first end surface (F1) satisfies Relational Expression 1: R1>R2. When the surface roughness (R2) of the second end surface (F2) and the surface roughness (R1) of the first end surface (F1) satisfy Relational Expression 1, formation of a translucent filling resin in a gap between the component (E1) and the first end surface (F1) of the optical waveguide 5 is unlikely to be hindered. It is thought that, in filling a resin into a gap between the first end surface (F1) and the component (E1), a filling resin is formed without any gap with respect to the second end surface (F2).

Through the processes illustrated in FIGS. 5A-5F, the formation of the optical waveguide 5 positioned on the support plate 6 is completed, and the optical wiring part 300 illustrated in FIG. 1 is formed. Further, the optical waveguide 5 may be formed separately from the support plate 6 and fixed to the support plate 6 using, for example, any adhesive (not illustrated). In forming the optical wiring part 300, the optical waveguide 5 may be fixed to the support plate 6 by any measure. When the wiring substrate (100a) without a support plate illustrated in FIG. 4 is manufactured, the optical waveguide 5 may be formed on the electrical wiring part 200, or the optical waveguide 5 may be fixed in contact with the electrical wiring part 200.

Next, as illustrated in FIG. 5G, the optical waveguide 5 fixed to the support plate 6 as the optical wiring part 300 is attached to a prepared electrical wiring part 200. The optical wiring part 300 may be fixed to a surface of the insulating layer 21 by any measure. The support plate 6 can be fixed to a surface of the insulating layer 21, for example using any adhesive (G).

For example, any adhesive (G), such as a thermosetting, room temperature curable, or photocurable adhesive, is supplied to a predetermined portion of the surface of the insulating layer 21 exposed from the solder resist 23, and the optical wiring part 300 having the optical waveguide 5 is mounted thereon. When necessary, a curing treatment of the adhesive (G) by heating or the like is performed, and the optical wiring part 300 is fixed. Through the above processes, the wiring substrate 100 in the example of FIG. 1 is completed.

Next, as illustrated in FIG. 5H, the components (E1, E2) are mounted on the wiring substrate 100. Specifically, the electrodes (E2a) of the component (E2) are connected to the conductor posts 14 via the connection layer 15 exposed on the surface 203 of the wiring substrate 100, and the electrodes (E1a) of the component (E1) are connected to the conductor posts 13 via the connection layer 15 exposed on the surface 203 of the wiring substrate 100. In particular, the light receiving or light emitting surface (E1c) of the light guiding part (E1b), which is a light receiving part or light emitting part of the component (optical element) (E1), is aligned to face the light transmitting surface (LF) of the core part 51 of the optical waveguide 5 and is placed on the second end surface (F2). The alignment between the light receiving or light emitting surface (E1c) and the light transmitting surface (LF) of the core part 51 can be performed with relatively high accuracy, as the light transmitting surface (LF) of the core part 51 is exposed on the first end surface (F1). After the components (E1, E2) are mounted on the wiring substrate 100, a gap between the component (E1) and the first end surface (F1) is filled with the filler (FR), which is a translucent filling resin, and the first end surface (F1) of the optical waveguide 5 and the surface where the light receiving or light emitting surface (E1c) of the component (E1) is exposed are fixed via the filler (FR). The filler (FR), which is a translucent filling resin, can also be formed in the recess (GR). The formation of the connection structure between the optical waveguide 5 and the component (E1) is completed.

The connection structure between the optical waveguide 5 and the component (optical element) (E1) on the wiring substrate 100 of the embodiment is not limited to the structures illustrated in the drawings, and is not limited to those having the structures, shapes, and materials exemplified in the present specification. In the connection structure of the embodiment, at least on the wiring substrate, the optical waveguide has: at one end part, the first end surface where the core part and the first cladding layer are exposed substantially flush; and the second end surface, which is a surface of the second cladding layer on the core part side extending from the first end surface. Further, the optical element is positioned on the second end surface such that the light receiving or light emitting surface thereof faces the light transmitting surface of the core part exposed on the first end surface. For example, the optical waveguide can have any number of core parts. Further, a thickness of a core part may vary from a first end part (51a) to a second end part (51b).

Japanese Patent Application Laid-Open Publication No. 2018-141910 describes an optical waveguide that includes a core layer, a first cladding layer laminated on a first main surface side of the core layer, and a second cladding layer laminated on a second main surface side of the core layer. An end surface of the second cladding layer is recessed from end surfaces of the core layer and the first cladding layer, and a portion of the second main surface of the core layer is exposed. When an optical interposer is connected to the optical waveguide, a light guiding part exposed on a lower surface of the optical interposer is positioned to face the exposed second main surface of the core layer, and optical connection is achieved.

In the optical waveguide described in Japanese Patent Application Laid-Open Publication No. 2018-141910, it is thought that alignment accuracy of the light guiding part of the optical interposer with respect to the core layer in the connection structure between the optical waveguide and the optical interposer may be relatively low. Further, since the optical interposer is positioned on the exposed core layer, it is also thought that damage may be caused due to contact with the core layer.

A connection structure according to an embodiment of the present invention includes an optical waveguide and an optical element on a wiring substrate. The optical waveguide includes: a core part having a first surface and a second surface on an opposite side with respect to the first surface; a first cladding layer formed in contact with the first surface; and a second cladding layer formed in contact with the second surface. One end part of the optical waveguide has a first end surface and a second end surface. The first end surface is a surface where the core part and the first cladding layer are substantially flush and where the core part is exposed. The second end surface is a surface of the second cladding layer that extends from the first end surface. The optical element has an exposed light receiving or light emitting surface. The light receiving or light emitting surface of the optical element faces a light transmitting surface of the core part that is exposed to the first end surface, and the optical element is positioned on the second end surface.

According to an embodiment of the present invention, in connecting an optical waveguide and an optical element, a connection structure between the optical waveguide and the optical element can be provided in which a light receiving or light emitting surface of a light guiding part, which is a light receiving part or light emitting part of the optical element, and a light transmitting surface of a core part of the optical waveguide are aligned with relatively high accuracy. Further, the optical element can be relatively stably positioned on the second end surface. Therefore, it is thought that a risk of contact between the exposed core part and the optical element is reduced, and damage to the core part is suppressed.

Obviously, numerous modifications and variations of the present invention are possible in light of the above teachings. It is therefore to be understood that within the scope of the appended claims, the invention may be practiced otherwise than as specifically described herein.

1. A connection structure, comprising:
an electrical wiring part;
an optical element positioned on an electrical part and having a light receiving surface or a light emitting surface; and
an optical waveguide positioned on the electrical wiring part and comprising a core part, a first cladding layer formed in contact with a first surface of the core part, and a second cladding layer formed in contact with a second surface of the core part on an opposite side with respect to the first surface,
wherein the optical waveguide has a first end surface and a second end surface formed such that the core part and the first cladding layer are substantially flush on the first end surface and that the second cladding layer has the second end surface extending from the first end surface, the core part of the optical waveguide has a light transmitting surface exposed on the first end surface and configured to face the light receiving surface or light emitting surface of the optical element, and the optical element is positioned on the second end surface of the optical waveguide.

2. The connection structure according to claim 1, wherein the second cladding layer of the optical waveguide has a recess at a corner part between the second cladding layer and the first end surface.

3. The connection structure according to claim 2, wherein the optical waveguide is formed such that the recess is formed in a region between and the first end surface and the light receiving or light emitting surface.

4. The connection structure according to claim 3, further comprising:
a resin filled between the first end surface and the light receiving or light emitting surface such that the resin is filling the recess formed in the optical waveguide.

5. The connection structure according to claim 1, wherein the optical waveguide is formed such that the core part is formed of an organic material, the first cladding layer is formed of an organic material, and the second cladding layer is formed of an organic material.

6. The connection structure according to claim 1, wherein the optical waveguide is formed such that a surface roughness R1 of the first end surface is 0.10 μm or less in arithmetic mean roughness.

7. The connection structure according to claim 1, wherein the optical waveguide is formed such that a surface roughness R2 of the second end surface is 0.10 μm or less in arithmetic mean roughness.

8. The connection structure according to claim 1, wherein the optical waveguide is formed such that a surface roughness R1 of the first end surface and a surface roughness R2 of the second end surface satisfy R1>R2.

9. The connection structure according to claim 1, wherein the electrical wiring part includes a plurality of conductive posts, and the optical element includes a plurality of electrodes configured to be electrically connected to the conductive posts of the electrical wiring part.

10. The connection structure according to claim 2, wherein the optical waveguide is formed such that the core part is formed of an organic material, the first cladding layer is formed of an organic material, and the second cladding layer is formed of an organic material.

11. The connection structure according to claim 2, wherein the optical waveguide is formed such that a surface roughness R1 of the first end surface is 0.10 μm or less in arithmetic mean roughness.

12. The connection structure according to claim 2, wherein the optical waveguide is formed such that a surface roughness R2 of the second end surface is 0.10 μm or less in arithmetic mean roughness.

13. The connection structure according to claim 2, wherein the optical waveguide is formed such that a surface roughness R1 of the first end surface and a surface roughness R2 of the second end surface satisfy R1>R2.

14. The connection structure according to claim 2, wherein the electrical wiring part includes a plurality of conductive posts, and the optical element includes a plurality of electrodes configured to be electrically connected to the conductive posts of the electrical wiring part.

15. The connection structure according to claim 3, wherein the optical waveguide is formed such that the core part is formed of an organic material, the first cladding layer is formed of an organic material, and the second cladding layer is formed of an organic material.

16. The connection structure according to claim 3, wherein the optical waveguide is formed such that a surface roughness R1 of the first end surface is 0.10 μm or less in arithmetic mean roughness.

17. The connection structure according to claim 3, wherein the optical waveguide is formed such that a surface roughness R2 of the second end surface is 0.10 μm or less in arithmetic mean roughness.

18. The connection structure according to claim 3, wherein the optical waveguide is formed such that a surface roughness R1 of the first end surface and a surface roughness R2 of the second end surface satisfy R1>R2.

19. The connection structure according to claim 3, wherein the electrical wiring part includes a plurality of conductive posts, and the optical element includes a plurality of electrodes configured to be electrically connected to the conductive posts of the electrical wiring part.

20. The connection structure according to claim 4, wherein the optical waveguide is formed such that the core part is formed of an organic material, the first cladding layer is formed of an organic material, and the second cladding layer is formed of an organic material.
